(19) United States
(12) Patent Application Publication
(10) Pub. No.: US 2023/0246751 A1
(43) Pub. Date: Aug. 3, 2023

(54) Full Adaptive Target BLER LTE Feature

(71) Applicant: Parallel Wireless, Inc., Nashua, NH (US)

(72) Inventors: Mohammad Jamal, Baqa-jatt (IL); Michael Yuzvinsky, Netanya (IL); Ido Shaked, Alfei Menashe (IL)

(21) Appl. No.: 18/161,887

(22) Filed: Jan. 30, 2023

Related U.S. Application Data
(60) Provisional application No. 63/304,075, filed on Jan. 28, 2022.

(51) Int. Cl. H04L 1/20; H04B 17/336

(52) U.S. Cl. CPC H04L 1/203; H04B 17/336

(57) ABSTRACT

A method of providing a full adaptive target BLER is described. In one embodiment, a method includes defining a first threshold; defining a second threshold; when voice traffic services are enabled, then setting the second threshold to a predetermined value; and when voice traffic service are not enabled, then setting the second threshold to a value corresponding to a current Signal to Interference and Noise Ratio (SINR) value.

### CROSS-REFERENCE TO RELATED APPLICATIONS

The present application claims priority under 35 U.S.C. § 119(e) to U.S. Provisional Pat. App. No. 63/304,075, having the same title as the present application and filed Jan. 28, 2022. In addition, the present application hereby incorporates by reference U.S. Pat. App. Pub. Nos. US20110044285, US20140241316; WO Pat. App. Pub. No. WO2013145592A1; EP Pat. App. Pub. No. EP2773151A1; U.S. Pat. No. 8,879,416, “Heterogeneous Mesh Network and Multi-RAT Node Used Therein,” filed May 8, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/777,246, “Methods of Enabling Base Station Functionality in a User Equipment,” filed Sep. 15, 2016; U.S. patent application Ser. No. 14/289,821, “Method of Connecting Security Gateway to Mesh Network,” filed May 29, 2014; U.S. patent application Ser. No. 14/642,544, “Federated X2 Gateway,” filed Mar. 9, 2015; U.S. patent application Ser. No. 14/711,293, “Multi-Egress Backhaul,” filed May 13, 2015; U.S. Pat. App. No. 62/375,341, “S2 Proxy for Multi-Architecture Virtualization,” filed Aug. 15, 2016; U.S. patent application Ser. No. 15/132,229, “MaxMesh: Mesh Backhaul Routing,” filed Apr. 18, 2016, each in its entirety for all purposes, having attorney docket numbers PWS-71700US01, 71710US01, 71717US01, 71721US01, 71756US01, 71762US01, 71819US00, and 71820US01, respectively. This application also hereby incorporates by reference in their entirety each of the following U.S. Pat. applications or Pat. App. Publications: US20150098387A1 (PWS-71731US01); US20170055186A1 (PWS-71815U501); US20170273134A1 (PWS-71850U501); US20170272330A1 (PWS-71850U502); and 15/713,584 (PWS-71850U503). This application also hereby incorporates by reference in their entirety U.S. patent application Ser. No. 16/424,479, “5G Interoperability Architecture,” filed May 28, 2019; and U.S. Provisional Pat. Application No. 62/804,209, “5G Native Architecture,” filed Feb. 11, 2019.

### BACKGROUND

The concept of BLER can be divided into two categories:

Initial BLER (IBLER): When the eNB sends data to the UE and UE is unable to decode it, then it will send a HARQ NACK to the eNB. A NACK means that the eNB will have to retransmit the data and this NACK is considered IBLER or Initial Block Error.

Residual BLER (RBLER): If the UE is unable to decode the data even after retransmission, the UE will send another NACK and the eNB will have to retransmit again. However, there is a limit to these retransmissions and usually they are configurable. Commonly, these retransmissions are set to 4 or 5 and after 4 or 5 retransmissions, the eNB will not retransmit at HARQ level and consider this as a Residual Block Error.

### SUMMARY

A method of providing a full adaptive target BLER is described. In one embodiment, a method includes defining a first threshold; defining a second threshold; when voice traffic services are enabled, then setting the second threshold to a predetermined value; and when voice traffic service are not enabled, then setting the second threshold to a value corresponding to a current Signal to Interference and Noise Ratio (SINR) value.

### BRIEF DESCRIPTION OF THE DRAWINGS

FIG. 1 is a plot of transport block size and MCS index, in accordance with some embodiments.

FIG. 2 is a plot of the concave curve

$$\frac{\partial T ( x , m )}{\partial m} ,$$

where m is the MCS index, in accordance with some embodiments.

FIG. 3 is a plot of optimal BLER and TBS (bits), in accordance with some embodiments.

FIG. 4 is an architecture diagram of a multi-RAT network architecture, in accordance with some embodiments.

FIG. 5 is a schematic diagram of a base station, in accordance with some embodiments.

FIG. 6 is a schematic diagram of a coordinating server, in accordance with some embodiments.

### DETAILED DESCRIPTION

Returning to the discussion above of BLER, the BLER target is maintained by the IBLER so this means that the eNB tries to maintain an IBLER of 10% for each UE, it aims to 10% because commonly Target BLER threshold is 10%. RBLER is usually very low and it is supposed to be less than 0.5%. The question may arise that why don't we reduce the IBLER further and make it low as that should reduce retransmissions? The problem here is that lowering IBLER means that we need to lower the MCS. Even a very low MCS will not ensure a linear decrease in IBLER but it will degrade throughput excessively. So, various simulations and field trials were done to come up with an optimum target BLER of 10% for IBLER which is followed by most of the vendors today.

Various simulations and field trials research were done to come up with an optimum target BLER of 10%. However, if we look more deeply on those various simulations and its relation to what happen practically we can conclude that BLER target of 10% works fine in fair conditions but when the radio conditions are bad or good, other BLER targets provide higher gains. For instance, if the radio conditions are bad, a BLER target of 10% keeps the MCS very conservative and increasing the BELR target, increases the MCS and it provides higher throughput gains. So, such parameters can be tuned if available to get better results.

To this fact a mathematics proofs with analysis are attached further on this paper and highlighted with demonstration.

The variable Target BLER is an enhancement on the original outer loop, because Target BLER strictly impact the outer loop, so our proposed in this paper deals with enhancement the outer loop because we implicitly enhance the Target BLER.

One significant point to be cautious to it that increasing BLER target means that the MCS will increase. So, it can improve throughput however depending on channel conditions and data volume, optimum BLER target can vary. If the BLER target is too high, then MCS will be increased but due to excessive retransmissions, the throughput and latency can be degraded. For this regard, we need to choose carefully the BLER target as this paper proposes.

Overview of Outer Loop Link Adaptation:

If the channel state information(Inner loop) isn't accurate then MCS level is too aggressive or too conservative so to overcome this drawback there's outer loop appear in background of Link Adaptation process. The mobile station detects the coding error and report the error to base station and then base station adjust this MCS level to satisfy the “target error rate”—Target BLER. for example if errors are too frequency(high rate of errors/high amount of crc errors) the Base station lower the mcs level and on the other hand if there's no error at all the base station increase their MCS level. That process is repeated at every packet transmission.

Mathematical proof of our proposed algorithm and contributions:

Primarily in this paper we will focus on target error rate (Target BLER), which a lot of previous work considers a fixed value of target BLER as 10% as Parallel Wireless adopted. And here is the issue comes, can we do better with this target error rate and not specifically keep it only on 10%? The answer is Yes and let's call it Optimal Target Error rate—Optimal Target BLER.

There are two contributions further will be explained which are around our invention: optimal target error rate Inversely related with SINR, and adapting target error rate to SINR. By those contributions we will have intensively higher throughput gain, specifically at low SINR region.

Our optimal criterion for this Outer Loop Link adaptation is to select the optimal MCS index m to maximize the effective throughput. And this can be derived by math equation:

Original criterion Mₒₚₜ:

$${M}_{opt} ( {x}_{1} , {x}_{2} , {x}_{3} , {x}_{4} … {x}_{{N}_{max}} ) = ( \begin{matrix}arg max \\ m\end{matrix} ) [ \frac{r ( m ) ( 1 - {\prod }_{i = 1}^{Nmax} {f}_{i} ( m , {x}_{i} )}{1 + {\sum }_{j = 1}^{Nmax - 1} {\prod }_{i = 1}^{j} {f}_{i} ( m , {x}_{i} )} ]$$

Effective Throughput mathematically denoted as R(m):

$$R ( m ) = [ \frac{\begin{matrix}E [ size of the transport blocks \\ decoded successfuly during HARQ process ]\end{matrix}}{\begin{matrix}E [ Number of transmission ( including an \\ initial transmission and retransmission ) ]\end{matrix}} ]$$

E( ) is Expectation probability function.

This is not feasible in practical system because: base station selects the MCS level once at the initial transmission, and base station can't predict the future SINRₛ(xᵢ, i=2 . . . ) and BLERₛ(fᵢ(m, xᵢ), i=2 . . . )

The base station can't predict the future SINR and BLER. So what actually we can do is to relaxing that criterion assuming that fᵢ (m, xᵢ)=fᵢ (m, x₁)=fᵢ (m, x_{N}) which means the future Block Error rate is same as current Block error rate and actually that's what “RELAX” criterion mean to the Original criterion. So a relaxed criterion is actually what currently eNB does and after “relaxing” the equation of original equation we can get:

$${m}_{opt} ( {x}_{1} ) = ( \begin{matrix}arg max \\ m\end{matrix} ) [ \frac{r ( m ) ( 1 - {\prod }_{i = 1}^{Nmax} {f}_{i} ( m , {x}_{i} )}{1 + {\sum }_{j = 1}^{Nmax - 1} {\prod }_{i = 1}^{j} {f}_{i} ( m , {x}_{i} )} ] {⟹}^{\begin{matrix}Nmax = 1 \\ i = 1\end{matrix}} ( \begin{matrix}arg max \\ m\end{matrix} ) [ \frac{r ( m ) ( 1 - {{f}_{1} ( m , {x}_{1} )}^{Nmax} )}{1 + {\sum }_{j = 1}^{Nmax - 1} ( {{f}_{1} ( m , {x}_{1} )}^{j} )} ] {⟹}^{Final Result} ( \begin{matrix}arg max \\ m\end{matrix} ) [ r ( m ) ( 1 - {f}_{1} ( m , {x}_{1} ) ) ]$$

So this relaxed equation represent post Target Bler value and post SINR, so implicitly this equation give us the future target Bler and future SINR. And This is actually what currently eNB does and what we have in Parallel Wireless.

One can see by this equation we can conclude two consequences:

TABLE 1

| | Transport | | Effective |
|---|---|---|---|
| MCS | block size | Initial BLER | Throughput |
| selection | r (m) | f₁ (m, x₁) | r (m) |
| | | | (1 − f₁ (m, x₁)) |
| If too | ↑ (big) | ↑ (too high) | ↓ (low) |
| aggressive | | | |
| too | ↓ (too small) | ↓ (too small) | ↓ (low) |
| conservative | | | |

So as you see here OPTIMIZATION is necessarily and strictly enhancement needed for Target BLER.

So basic idea we are trying to apply in our proposed algorithm is as follows. The variable Target BLER is an enhancement on the original outer loop control algorithm. Originally BLER of 10% was used, but with this, the BLER target can vary between 30% and 10%. The basic idea is that low CQI users can use a higher BLER target to optimize resource efficiency. It also adds a criterion about packet size based on TBS to the algorithm such that smaller packets get assigned to higher BLER target.

Modeling and Approximation

We can model that TBS as: r₍ₘ₎−r₍ₘ₋₁₎≈Y

We can mathematically model the Target BLER function as exponent function as following: Target BLER function: fᵢ(m, x₁)≈e^{-a(x-g(m))}; g(m)−g(m−1)≈β; where γ, β are constants.

Table of MCS indexes corresponded to TBS index as shown in the 3GPP spec:

TABLE 2
Table 7.1.7.1-1: Modulation and
TBS index table for PDSCH

| MCS index | Modulation | TBS index |
|---|---|---|
| [symbol] | Order [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | [symbol] |
| [symbol] | [symbol] | reserved |
| [symbol] | [symbol] | |
| [symbol] | [symbol] | |

[symbol]

indicates data missing or illegible when filed

The accurate size of transport block is shown in Table 3 from 3GPP standard:

TABLE 3
Table 7.1.7.2.1-1: Transport block size table (dimension 27 × 110)

| | N_{PRB} | | | | | | | | | |
|---|---|---|---|---|---|---|---|---|---|---|
| I_{TBS} | 1 | 2 | 3 | 4 | 5 | 6 | 7 | 8 | 9 | 10 |
| 0 | 16 | 32 | 56 | 88 | 120 | 152 | 176 | 208 | 224 | 256 |
| 1 | 24 | 56 | 88 | 144 | 176 | 208 | 224 | 256 | 328 | 344 |
| 2 | 32 | 72 | 144 | 176 | 208 | 256 | 296 | 328 | 376 | 424 |
| 3 | 40 | 104 | 176 | 208 | 256 | 328 | 392 | 440 | 504 | 568 |
| 4 | 56 | 120 | 208 | 256 | 328 | 408 | 488 | 552 | 632 | 696 |
| 5 | 72 | 144 | 224 | 328 | 424 | 504 | 600 | 680 | 776 | 872 |
| 6 | 328 | 176 | 256 | 392 | 504 | 600 | 712 | 808 | 936 | 1032 |
| 7 | 104 | 224 | 328 | 472 | 584 | 712 | 840 | 968 | 1096 | 1224 |
| 8 | 120 | 256 | 392 | 536 | 680 | 808 | 968 | 1096 | 1256 | 1384 |
| 9 | 136 | 296 | 456 | 616 | 776 | 936 | 1096 | 1256 | 1416 | 1544 |
| 10 | 144 | 328 | 504 | 680 | 872 | 1032 | 1224 | 1384 | 1544 | 1736 |
| 11 | 176 | 376 | 584 | 776 | 1000 | 1192 | 1384 | 1608 | 1800 | 2024 |
| 12 | 208 | 440 | 680 | 904 | 1128 | 1352 | 1608 | 1800 | 2024 | 2280 |
| 13 | 224 | 488 | 744 | 1000 | 1256 | 1544 | 1800 | 2024 | 2280 | 2536 |
| 14 | 256 | 552 | 840 | 1128 | 1416 | 1736 | 1992 | 2280 | 2600 | 2856 |
| 15 | 280 | 600 | 904 | 1224 | 1544 | 1800 | 2152 | 2472 | 2728 | 3112 |
| 16 | 328 | 632 | 968 | 1288 | 1688 | 1928 | 2280 | 2600 | 2984 | 3240 |
| 17 | 336 | 696 | 1064 | 1416 | 1800 | 2152 | 2536 | 2856 | 3240 | 3624 |
| 18 | 376 | 776 | 1160 | 1544 | 1992 | 2344 | 2792 | 3112 | 3624 | 4008 |
| 19 | 408 | 840 | 1288 | 1736 | 2152 | 2600 | 2984 | 3496 | 3880 | 4264 |
| 20 | 440 | 904 | 1384 | 1864 | 2344 | 2792 | 3240 | 3752 | 4136 | 4584 |
| 21 | 488 | 1000 | 1480 | 1992 | 2472 | 2984 | 3496 | 4008 | 4584 | 4968 |
| 22 | 520 | 1064 | 1608 | 2152 | 2664 | 3240 | 3752 | 4264 | 4776 | 5352 |
| 23 | 552 | 1128 | 1736 | 2280 | 2856 | 3496 | 4008 | 4584 | 5160 | 5736 |
| 24 | 584 | 1192 | 1800 | 2408 | 2984 | 3624 | 4264 | 4968 | 5544 | 5992 |

We define this Transport block size table as I_{TBS} matrix.

Matlab Simulation:

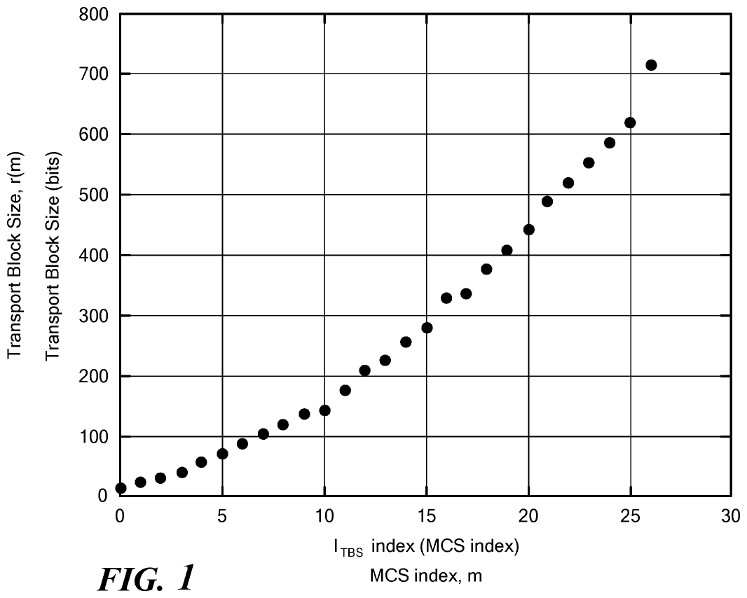

FIG. 1 shows a plot of transport block size against MCS index, in accordance with some embodiments. Taking average of TBS values per chosen MCS index, because for certain MCS index m there's more than TBS size can be chosen so we took the average of all TB S values for this correspond MCS index m.

For example, if MCS_Index_m=(0:30); y=mean(I_{TBS}, 2); % average of I_{TBS} matrix of transport block table per each row; plot(MCS_Index_m,y,‘b’,‘LineWidth’,4); with ylim([0 0.8]), with the y axis being Transport block size r(m) and the x axis being MCS index,m, the plot as shown is generated.

As we see according to the graph of TBS versus MCS index m, we fairly can model it to a linear graph (i.e constant slope), which means a linear relation exists between TransportBlock to correspond MCS index,m. Consequently, under our approximation modeling we can say linear relation between Transport Block to SINR values and this is because we conclude Transport block is linear to MCS index,m under our modeling so due to fact that SINR is linear to MSC index, m so we can fairly in implicit way say that transport block is linearly related to SINR.

Here in our paper we are trying to find out implicitly the optimal target BLER adapted to current SINR So the optimal target BLER is achieved by choosing the optimal MCS index,m which will lead to the optimal Target BLER—here is the point comes that fixed target BLER isn't give us much gain in all conditions (bad/fair/good). In fair conditions as we denoted above it's Okay, but what about others conditions?

Optimal target BLER mathematically is denoted as following below. The Optimal target BLER acquired when choosing MCS index,m optimally which means that optimal MCS index,m maximizes the throughput, So we can say mathematically that optimal MCS equation is: (we choose the maximum upon m variable which give us the most best throughput).

$${m}_{opt} ( x ) = ( \begin{matrix}arg max \\ m\end{matrix} ) [ r ( m ) ( 1 - {f}_{1} {\underbrace{( m , {x}_{1} ) ) ]}}_{{↓}_{T ( x , m )}}$$

So now lets assume the MSC index, m is continuous real number of MCS indexes (practically it's not continuous—it's discrete as practically, but please bear with us and read till the end):

@lets define=:T(x,m)=r(m)(1−f₁(m,x₁))

So if we do derivative twice to that function which means:

$$\frac{{\partial }^{2} T ( x , m )}{\partial m} < 0$$

so because its always negative then it's concave curve.

So lets find exact points where we can get the optimal MCS index m which must give us the maximum point over that concave curve

$$\frac{{\partial }^{2} T ( x , m )}{\partial m} .$$

So we require that

$$\frac{\partial T ( x , m )}{\partial m} = 0$$

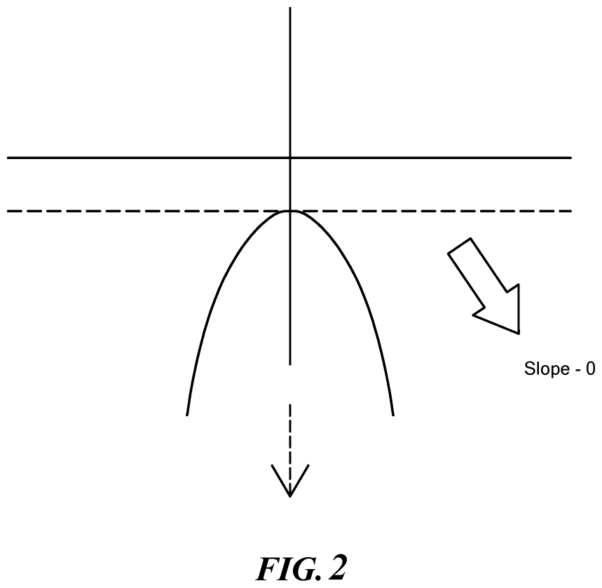

because we need the slope to be zero to get best optimal chosen MSC index m, and this satisfy when slope is zero. FIG. 2 is such a plot of the concave curve

$$\frac{\partial T ( x , m )}{\partial m} ,$$

where m is the MCS index, in accordance with some embodiments.

$${m}_{opt} for \frac{\partial T ( x , m )}{\partial m} = 0 \to γ - ( γ + α β r ( m ) ) {e}^{- α ( x - g ( m ) )} = 0 \\ {f}_{( {m}_{opt} , x )} = {e}^{- α ( x - g ( m ) )} = \frac{1}{1 + \frac{α β}{γ} r ( {m}_{opt} )} , \frac{α β}{γ} = constant ,$$

r(mₒₚₜ) is implicitly TBS (transport block size) when the optimal MCS is selected

f(mₒₚₜ,x) is the Optimal Target BLER function.

So implicitly we see here this inversely relation between Optimal BLER to r(mₒₚₜ) and we already know that r(mₒₚₜ) is linear related to SINR so we can conclude this implicitly logic:

High SINR [symbol] Optimal Target BLER is lower.

Low SINR [symbol] Optimal Target BLER is higher.

So about our assumption that MCS set is continuous function and it's not as practically we have, since practically described as mathematically as discrete function So

$${\hat{m}}_{opt} ( x ) = ( \begin{matrix}arg max \\ M\end{matrix} ) [ r ( m ) ( 1 - {f}_{1} ( m , {x}_{1} ) ) ]$$

M: Set of MCS indices.

\hat{m}∈M

This is actually the discrete form formula for choosing optimal MCS index m that give us optimal Target BLER (or vice versa). The behind logic of continuous formula is also apply on the discrete formula of optimal MCS index m.

In order to analyze the discrete formula and how it behaves then we can find out the lower bound and the upper bound:

Upper bound satisfied when:

T(\hat{m}ₒₚₜ,x)≥(mₒₚₜ−1,x)

So then we get the upper bound of Optimal Target BLER:

$${f}_{( {\hat{m}}_{opt} , x )} \leq \frac{γ}{γ {e}^{- α β} + r ( {\hat{m}}_{opt} ) ( 1 - {e}^{- α β} )}$$

Lower bound satisfied when:

T(mₒₚₜ,x)≥(\hat{m}ₒₚₜ+1,x)

So then we get the upper bound of Optimal Target BLER:

$${f}_{( {\hat{m}}_{opt} , x )} \leq \frac{γ}{γ {e}^{α β} + r ( {\hat{m}}_{opt} ) ( {e}^{α β} + 1 )}$$

We see straightforwardly that UPPER and the lower bound of target BLER with optimal chosen MCS index m (\hat{m}ₒₚₜ) the relation between Target BLER threshold to Transport Block Size r(\hat{m}ₒₚₜ) are inversely related so when we have two conclusions:

If big Transport block size (high packet size) then target BLER shall be low.

If small Transport block size (small packets) then Target BLER shall be high.

By upper and lower bound we figured out this two conclusions but we know from math that if upper bound and lower bound behave the same thing in the same logic then the function optimal Target BLER f(mₚ,x) must behave in the same logic of UPPER/LOWER bound behavior and this is according to calculus theorem called the sandwich/squeeze theorem.

So to sum up we can say that the function optimal Target BLER f(_{\hat{m}}_{ₒₚₜ},x) totally in all its cases (range between upper/lower bounds) behaves in the same logic and has the same two conclusions as mentioned above.

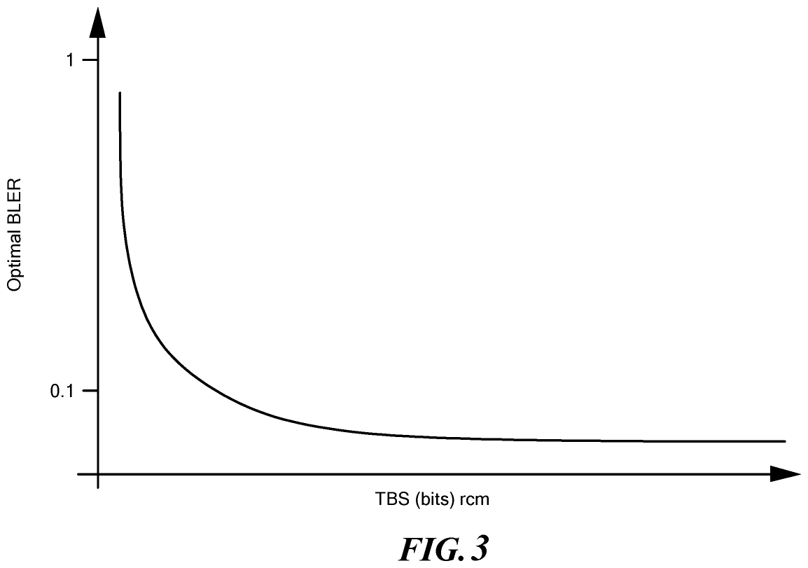

FIG. 3 shows this relationship as a plot of optimal BLER versus TBS (bits) rcm.

All in all, after we dealt and analyzed above the optimal Target BLER, we can majorly conclude the following two conclusions in this paper for OLLA (Outer loop link adaptation) enhancement:

Adapting the TARGET BLER based on the average SINR, it follows that (1) High target BLER at LOW SINR and (2) Low target BLER at HIGH SINR are appropriate.

Those two contributions means (3) the optimal BLER is inversely related to the SINR.

So the optimum target BLER function can be the upper bound of Optimal Target BLER function or the lower bound function of Optimal Target BLER (as shown in two cases above) or any function definition that range between those two cases (upper—lower). Therefore definition of the optimum target BLER can be any of these three possibilities and all those possibilities will give us much higher throughput than the prior art.

NOTE 1. In this paper we have decided to define the optimum target BLER function as the upper bound of Optimal Target BLER function:

$${f}_{( {\hat{m}}_{opt} , x )} = \frac{γ}{γ {e}^{- α β} + r ( {\hat{m}}_{opt} ) ( 1 - {e}^{- α β} )}$$

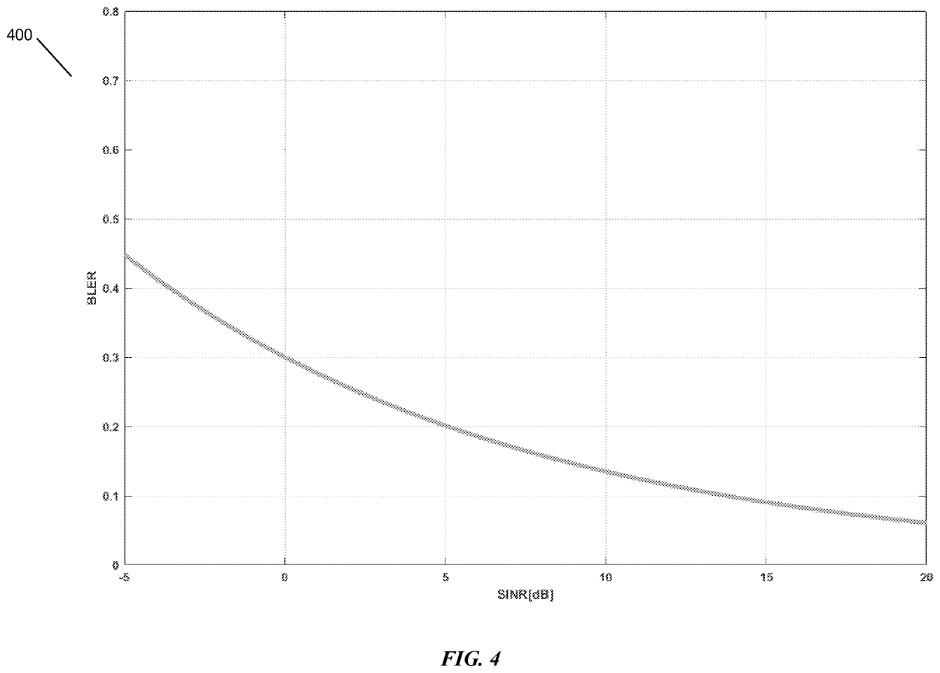

FIG. 4 shows the result of using this optimal Target BLER function above versus different SINR values.

Beyond to what mentioned/explained above, the feature is adaptively assign optimal Target BLER to current SINR and not keeping Target BLER fixed at 10%.

Problem:

Low data throughput gain and Low spectral efficiency when Target BLER threshold fixed at 10%.

### Solution to Problem

Parallel Wireless (PW) architecture can provide a solution to this problem by just updating in the gNB scheduler our proposed Algorithm:

#define Target_BLER_threshold Adaptive_Target BLER_threshold

If (QCI 1 and 2 is satisfied)//QCI 1 and 2 means voice traffic services enabled.

We designed this condition to totally beat the possibility of higher drop call rate. So we keep Adaptive_Target_BLER=10%. Else (i.e for any current SINR),

Adaptive_Target_BLER_threshold=this threshold BLERₛ values are assigned adaptively to the current SINR values according to graph/lookup table mentioned above in NOTE 1.

For example if current SINR=5 [db] then according to graph/lookup table NOTE 1 Adaptive_Target_BLER_threshold=0.2. and so on for others SINR values.

The gain acquired by our proposed technique algorithm is much higher, about throughput to 40%-50% compared to fixed BLER threshold.

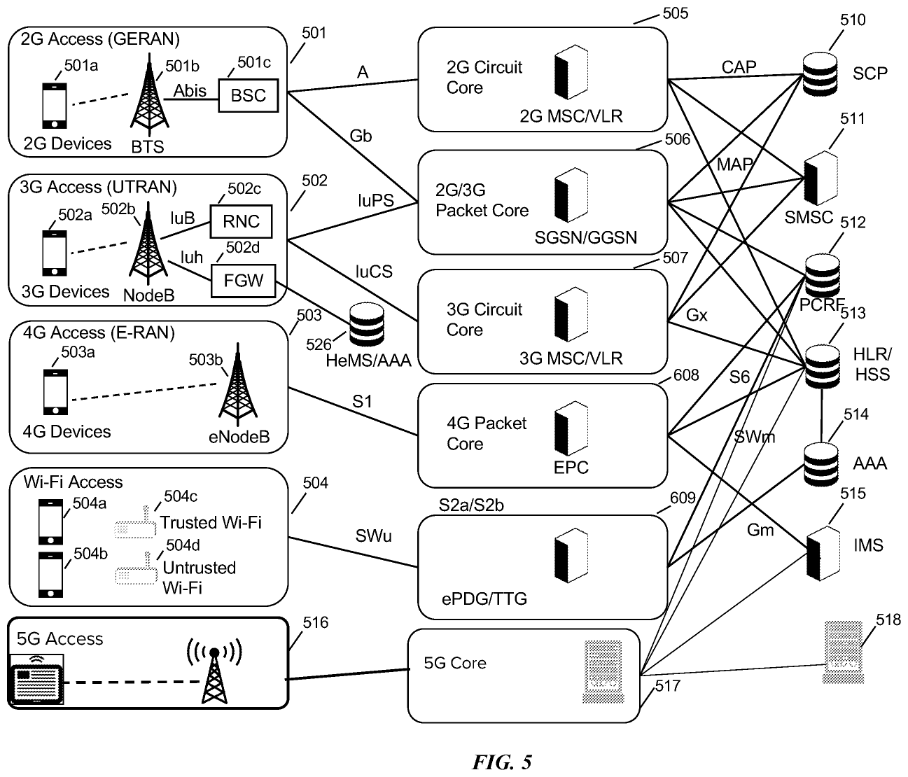

FIG. 5 is a schematic network architecture diagram for 3G and other-G prior art networks. The diagram shows a plurality of “Gs,” including 2G, 3G, 4G, 5G and Wi-Fi. 2G is represented by GERAN 501, which includes a 2G device 501a, BTS 501b, and BSC 501c. 3G is represented by UTRAN 502, which includes a 3G UE 502a, nodeB 502b, RNC 502c, and femto gateway (FGW, which in 3GPP namespace is also known as a Home nodeB Gateway or HNBGW) 502d. 4G is represented by EUTRAN or E-RAN 503, which includes an LTE UE 503a and LTE eNodeB 503b. Wi-Fi is represented by Wi-Fi access network 504, which includes a trusted Wi-Fi access point 504c and an untrusted Wi-Fi access point 504d. The Wi-Fi devices 504a and 504b may access either AP 504c or 504d. In the current network architecture, each “G” has a core network. 2G circuit core network 505 includes a 2G MSC/VLR; 2G/3G packet core network 506 includes an SGSN/GGSN (for EDGE or UMTS packet traffic); 3G circuit core 507 includes a 3G MSC/VLR; 4G circuit core 508 includes an evolved packet core (EPC); and in some embodiments the Wi-Fi access network may be connected via an ePDG/TTG using S2a/S2b. Each of these nodes are connected via a number of different protocols and interfaces, as shown, to other, non-“G”-specific network nodes, such as the SCP 530, the SMSC 531, PCRF 532, HLR/HSS 533, Authentication, Authorization, and Accounting server (AAA) 534, and IP Multimedia Subsystem (IMS) 535. An HeMS/AAA 536 is present in some cases for use by the 3G UTRAN. The diagram is used to indicate schematically the basic functions of each network as known to one of skill in the art, and is not intended to be exhaustive. For example, 5G core 517 is shown using a single interface to 5G access 516, although in some cases 5G access can be supported using dual connectivity or via a non-standalone deployment architecture.

Noteworthy is that the RANs 501, 502, 503, 504 and 536 rely on specialized core networks 505, 506, 507, 508, 509, 537 but share essential management databases 530, 531, 532, 533, 534, 535, 538. More specifically, for the 2G GERAN, a BSC 501c is required for Abis compatibility with BTS 501b, while for the 3G UTRAN, an RNC 502c is required for Iub compatibility and an FGW 502d is required for Iuh compatibility. These core network functions are separate because each RAT uses different methods and techniques. On the right side of the diagram are disparate functions that are shared by each of the separate RAT core networks. These shared functions include, e.g., PCRF policy functions, AAA authentication functions, and the like. Letters on the lines indicate well-defined interfaces and protocols for communication between the identified nodes.

The system may include 5G equipment. 5G networks are digital cellular networks, in which the service area covered by providers is divided into a collection of small geographical areas called cells. Analog signals representing sounds and images are digitized in the phone, converted by an analog to digital converter and transmitted as a stream of bits. All the 5G wireless devices in a cell communicate by radio waves with a local antenna array and low power automated transceiver (transmitter and receiver) in the cell, over frequency channels assigned by the transceiver from a common pool of frequencies, which are reused in geographically separated cells. The local antennas are connected with the telephone network and the Internet by a high bandwidth optical fiber or wireless backhaul connection.

5G uses millimeter waves which have shorter range than microwaves, therefore the cells are limited to smaller size. Millimeter wave antennas are smaller than the large antennas used in previous cellular networks. They are only a few inches (several centimeters) long. Another technique used for increasing the data rate is massive MIMO (multiple-input multiple-output). Each cell will have multiple antennas communicating with the wireless device, received by multiple antennas in the device, thus multiple bitstreams of data will be transmitted simultaneously, in parallel. In a technique called beamforming the base station computer will continuously calculate the best route for radio waves to reach each wireless device, and will organize multiple antennas to work together as phased arrays to create beams of millimeter waves to reach the device.

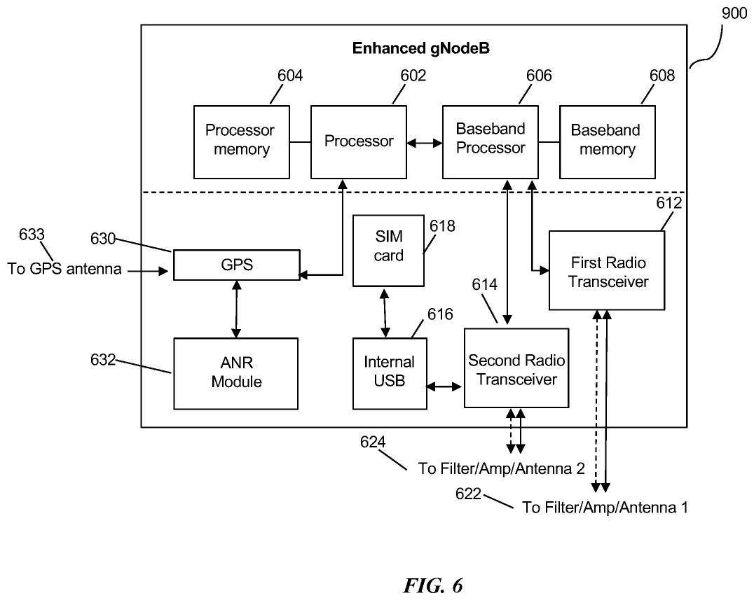

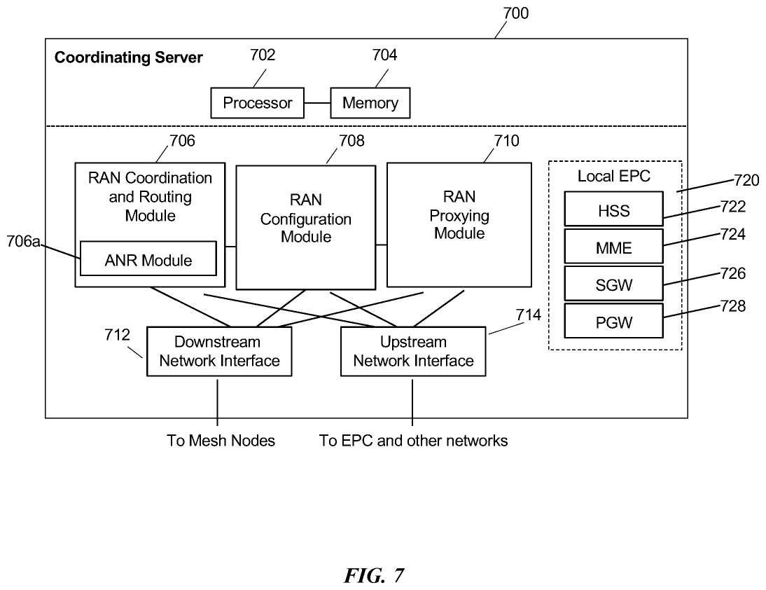

FIG. 6 is an enhanced eNodeB for performing the methods described herein, in accordance with some embodiments. eNodeB 600 may include processor 602, processor memory 604 in communication with the processor, baseband processor 606, and baseband processor memory 608 in communication with the baseband processor. Mesh network node 600 may also include first radio transceiver 612 and second radio transceiver 614, internal universal serial bus (USB) port 616, and subscriber information module card (SIM card) 618 coupled to USB port 616. In some embodiments, the second radio transceiver 614 itself may be coupled to USB port 616, and communications from the baseband processor may be passed through USB port 616. The second radio transceiver may be used for wirelessly backhauling eNodeB 600.

Processor 602 and baseband processor 606 are in communication with one another. Processor 602 may perform routing functions, and may determine if/when a switch in network configuration is needed. Baseband processor 606 may generate and receive radio signals for both radio transceivers 612 and 614, based on instructions from processor 602. In some embodiments, processors 602 and 606 may be on the same physical logic board. In other embodiments, they may be on separate logic boards.

Processor 602 may identify the appropriate network configuration, and may perform routing of packets from one network interface to another accordingly. Processor 602 may use memory 604, in particular to store a routing table to be used for routing packets. Baseband processor 606 may perform operations to generate the radio frequency signals for transmission or retransmission by both transceivers 610 and 612. Baseband processor 606 may also perform operations to decode signals received by transceivers 612 and 614. Baseband processor 606 may use memory 608 to perform these tasks.

The first radio transceiver 612 may be a radio transceiver capable of providing LTE eNodeB functionality, and may be capable of higher power and multi-channel OFDMA. The second radio transceiver 614 may be a radio transceiver capable of providing LTE UE functionality. Both transceivers 612 and 614 may be capable of receiving and transmitting on one or more LTE bands. In some embodiments, either or both of transceivers 612 and 614 may be capable of providing both LTE eNodeB and LTE UE functionality. Transceiver 612 may be coupled to processor 602 via a Peripheral Component Interconnect-Express (PCI-E) bus, and/or via a daughtercard. As transceiver 614 is for providing LTE UE functionality, in effect emulating a user equipment, it may be connected via the same or different PCI-E bus, or by a USB bus, and may also be coupled to SIM card 618. First transceiver 612 may be coupled to first radio frequency (RF) chain (filter, amplifier, antenna) 622, and second transceiver 614 may be coupled to second RF chain (filter, amplifier, antenna) 624.

SIM card 618 may provide information required for authenticating the simulated UE to the evolved packet core (EPC). When no access to an operator EPC is available, a local EPC may be used, or another local EPC on the network may be used. This information may be stored within the SIM card, and may include one or more of an international mobile equipment identity (IMEI), international mobile subscriber identity (IMSI), or other parameter needed to identify a UE. Special parameters may also be stored in the SIM card or provided by the processor during processing to identify to a target eNodeB that device 600 is not an ordinary UE but instead is a special UE for providing backhaul to device 600.

Wired backhaul or wireless backhaul may be used. Wired backhaul may be an Ethernet-based backhaul (including Gigabit Ethernet), or a fiber-optic backhaul connection, or a cable-based backhaul connection, in some embodiments. Additionally, wireless backhaul may be provided in addition to wireless transceivers 612 and 614, which may be Wi-Fi 802.11a/b/g/n/ac/ad/ah, Bluetooth, ZigBee, microwave (including line-of-sight microwave), or another wireless backhaul connection. Any of the wired and wireless connections described herein may be used flexibly for either access (providing a network connection to UEs) or backhaul (providing a mesh link or providing a link to a gateway or core network), according to identified network conditions and needs, and may be under the control of processor 602 for reconfiguration.

A GPS module 630 may also be included, and may be in communication with a GPS antenna 632 for providing GPS coordinates, as described herein. When mounted in a vehicle, the GPS antenna may be located on the exterior of the vehicle pointing upward, for receiving signals from overhead without being blocked by the bulk of the vehicle or the skin of the vehicle. Automatic neighbor relations (ANR) module 632 may also be present and may run on processor 602 or on another processor, or may be located within another device, according to the methods and procedures described herein.

Other elements and/or modules may also be included, such as a home eNodeB, a local gateway (LGW), a self-organizing network (SON) module, or another module. Additional radio amplifiers, radio transceivers and/or wired network connections may also be included.

FIG. 7 is a coordinating server for providing services and performing methods as described herein, in accordance with some embodiments. Coordinating server 700 includes processor 702 and memory 704, which are configured to provide the functions described herein. Also present are radio access network coordination/routing (RAN Coordination and routing) module 706, including ANR module 706a, RAN configuration module 708, and RAN proxying module 710. The ANR module 706a may perform the ANR tracking, PCI disambiguation, ECGI requesting, and GPS coalescing and tracking as described herein, in coordination with RAN coordination module 706 (e.g., for requesting ECGIs, etc.). In some embodiments, coordinating server 700 may coordinate multiple RANs using coordination module 706. In some embodiments, coordination server may also provide proxying, routing virtualization and RAN virtualization, via modules 710 and 708. In some embodiments, a downstream network interface 712 is provided for interfacing with the RANs, which may be a radio interface (e.g., LTE), and an upstream network interface 714 is provided for interfacing with the core network, which may be either a radio interface (e.g., LTE) or a wired interface (e.g., Ethernet).

Coordinator 700 includes local evolved packet core (EPC) module 720, for authenticating users, storing and caching priority profile information, and performing other EPC-dependent functions when no backhaul link is available. Local EPC 720 may include local HSS 722, local MME 724, local SGW 726, and local PGW 728, as well as other modules. Local EPC 720 may incorporate these modules as software modules, processes, or containers. Local EPC 720 may alternatively incorporate these modules as a small number of monolithic software processes. Modules 706, 708, 710 and local EPC 720 may each run on processor 702 or on another processor, or may be located within another device.

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server, when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods for providing interference mitigation are described in reference to the Long Term Evolution (LTE) standard, one of skill in the art would understand that these systems and methods could be adapted for use with other wireless standards or versions thereof. The inventors have understood and appreciated that the present disclosure could be used in conjunction with various network architectures and technologies. Wherever a 4G technology is described, the inventors have understood that other RATs have similar equivalents, such as a gNodeB for 5G equivalent of eNB. Wherever an MME is described, the MME could be a 3G RNC or a 5G AMF/SMF. Additionally, wherever an MME is described, any other node in the core network could be managed in much the same way or in an equivalent or analogous way, for example, multiple connections to 4G EPC PGWs or SGWs, or any other node for any other RAT, could be periodically evaluated for health and otherwise monitored, and the other aspects of the present disclosure could be made to apply, in a way that would be understood by one having skill in the art.

Additionally, the inventors have understood and appreciated that it is advantageous to perform certain functions at a coordination server, such as the Parallel Wireless HetNet Gateway, which performs virtualization of the RAN towards the core and vice versa, so that the core functions may be statefully proxied through the coordination server to enable the RAN to have reduced complexity. Therefore, at least four scenarios are described: (1) the selection of an MME or core node at the base station; (2) the selection of an MME or core node at a coordinating server such as a virtual radio network controller gateway (VRNCGW); (3) the selection of an MME or core node at the base station that is connected to a 5G-capable core network (either a 5G core network in a 5G standalone configuration, or a 4G core network in 5G non-standalone configuration); (4) the selection of an MME or core node at a coordinating server that is connected to a 5G-capable core network (either 5G SA or NSA). In some embodiments, the core network RAT is obscured or virtualized towards the RAN such that the coordination server and not the base station is performing the functions described herein, e.g., the health management functions, to ensure that the RAN is always connected to an appropriate core network node. Different protocols other than SlAP, or the same protocol, could be used, in some embodiments.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

In some embodiments, the software needed for implementing the methods and procedures described herein may be implemented in a high level procedural or an object-oriented language such as C, C++, C #, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, 2G, 3G, 5G, TDD, or other air interfaces used for mobile telephony.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, or to networks for additional protocols that utilize radio frequency data transmission. Various components in the devices described herein may be added, removed, split across different devices, combined onto a single device, or substituted with those having the same or similar functionality.

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment.

1. A method for improving user equipment (UE) throughput in a wireless system by performing outer loop link adaptation, comprising:
at a base station scheduler, defining a target block error rate (BLER) threshold;
at the base station scheduler, defining an adaptive target BLER threshold;
when voice traffic services are enabled, then setting the adaptive target BLER threshold to a predetermined value; and
when voice traffic service are not enabled, then setting the adaptive target BLER threshold to a target threshold value according to a current Signal to Interference and Noise Ratio (SINR) value.

2. The method of claim 1, wherein the base station scheduler is a gNodeB scheduler.

3. The method of claim 1, wherein the target threshold value is set to a high value when the current SINR is low.

4. The method of claim 1, wherein the target threshold value is set to a low value when the current SINR is high.

5. The method of claim 1, wherein the target threshold value is set to a value that is inversely related to the current SINR.

6. The method of claim 1, wherein the target threshold value is set to a value based on the upper bound of the function
$${f}_{( {\hat{m}}_{opt} , x )} = \frac{γ}{γ {e}^{- α β} + r ( {\hat{m}}_{opt} ) ( 1 - {e}^{- α β} )} .$$
